(19) United States
(12) Patent Application Publication
(10) Pub. No.: US 2010/0250812 A1
(43) Pub. Date: Sep. 30, 2010

(54) ELECTRONIC MULTIPURPOSE CARD

(76) Inventors: Richard Webb, Dana Point, CA (US); Randall Bertuccelli, Walnut Creek, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/713,023

(22) Filed: Feb. 25, 2010

Related U.S. Application Data
(60) Provisional application No. 61/155,863, filed on Feb. 26, 2009.

(51) Int. Cl. G06K 19/067; G06F 7/04; G06F 12/02; G06F 13/38

(52) U.S. Cl. 710/301; 340/5.82; 235/487; 711/103; 711/E12.008

(57) ABSTRACT

Cards having functionality of multiple card types. A user simply selects the appropriate card type and date specific to that card type is made accessible to card readers or other data reading means. Certain cards include biometric readers that provide enhanced security against unauthorized use. Only the appropriate owner of the card is able to activate and use a card by way of a biometric scan of his/her own skin.

### CROSS-REFERENCES TO RELATED APPLICATIONS

This application claims the benefit of U.S. Provisional Application Ser. No. 61/155,863, filed Feb. 26, 2009, entitled “Electronic Multipurpose Card,” which is hereby incorporated by reference in its entirety for all purposes.

### BACKGROUND

The present invention relates generally to a personal card for storing and retrieving information in an optional, secure manner.

Cards of various types are ubiquitous these days. Users typically carry and use multiple cards such as credit cards, ATM cards, stored value cards and numerous others. The clutter of cards can often times be irritating to a user. Also, when misplaced or stolen, these cards are subject to unauthorized use which ultimately could cost the user and/or card issuer.

Accordingly it is desirable to provide users with cards that offer a higher level of security against unauthorized use. Additionally, it is desirable to provide users with a single card that offers a user the functionality of multiple cards.

### BRIEF SUMMARY OF THE INVENTION

The present invention provides cards having functionality of multiple card types. A user simply selects the appropriate card type and date specific to that card type is made accessible to card readers or other data reading means. The present invention also provides cards with biometric readers that provide enhanced security against unauthorized use. Only the appropriate owner of the card is able to activate and use a card by way of a biometric scan of his/her own skin.

According to one embodiment, a card is provided that includes a biometric reader element, one of a FireWire connection interface element or a Universal Serial Bus connection interface element, and a memory for storing information, including information personal to a user. In certain aspects, the card is a multi-function card wherein information specific to a plurality of different card types is stored in the memory, and wherein the card further includes a selection element that allows a user to select one of the plurality of card types, wherein upon selection by a user of a card type, the selected card type is activated such that information available from the card corresponds only to the activated card type.

According to another embodiment, a method is provided of activating a card having a biometric reader element, and a memory for storing information personal to a user. The method typically includes activating the biometric reader element, and performing a biometric scan of a user to activate the card. In certain aspects, the card includes a Firewire or Universal Serial Bus (USB) connector element to allow data exchange between the card and external systems or devices. In certain aspects, the method also includes connecting the card to a device or network using the connector element and transferring information between the memory and the device or network over the connector element. In certain aspects, performing a biometric scan includes obtaining spectral measurements of a user's skin and comparing the spectral measurements with information stored in the memory. In certain aspects, information specific to a plurality of different card types is stored in the memory, and wherein the card further includes a selection element that allows a user to activate one of the plurality of card types, and wherein the method further includes activating a specific card type using the selection element, whereby information in the memory specific to that card type is made accessible to a card reader or a system connected with the connector element.

According to a further embodiment, a card is provided that typically includes a memory for storing information specific to a plurality of different card types, and a selection element that allows a user to select one of the plurality of card types, wherein upon selection by a user of a card type, the selected card type is activated such that information available or accessible from the memory of the card corresponds only to the activated card type. In certain aspects, the card also includes one of a FireWire connection interface element or a Universal Serial Bus connection interface element or other connection element or means.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

FIG. 1 illustrates a front and back view of an example of a biometric firewire connect card according to one embodiment.

FIG. 2 illustrates a front and back view of an example of a biometric firewire connect card including embossed or printed information on the card according to one embodiment.

FIG. 3 illustrates a front and back view of an example of a card mold (e.g., plastic) for use as a biometric firewire connect card according to one embodiment.

FIG. 4 illustrates a front view of a multipurpose card including functionality for implementing more than one card type on a single physical card.

FIG. 5 illustrates a back view of a multipurpose card including functionality for implementing more than one card type on a single physical card.

FIG. 6 illustrates such a card according to one embodiment. FIG. 6a shows an isometric view of a card with a connector element that is substantially the same thickness as the card. FIG. 6b illustrates a side view with elements of the connector element shown in a detached state.

### DETAILED DESCRIPTION OF THE INVENTION

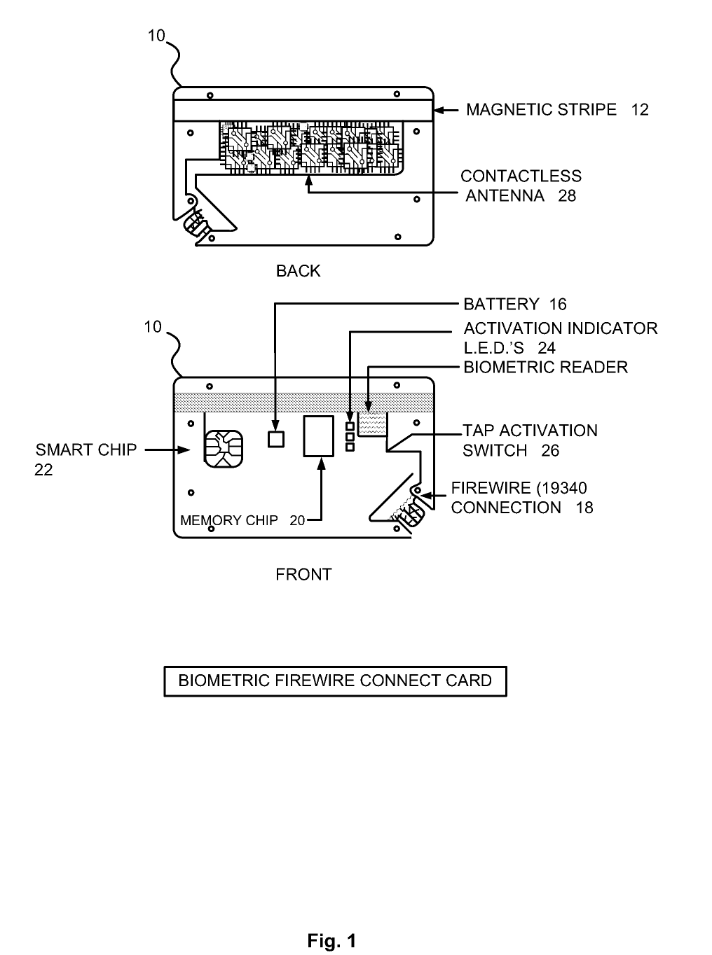

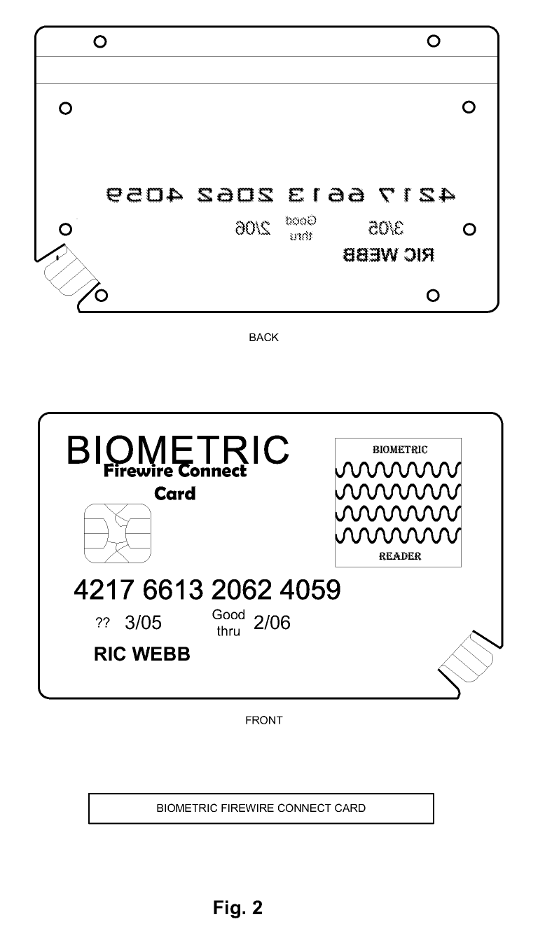

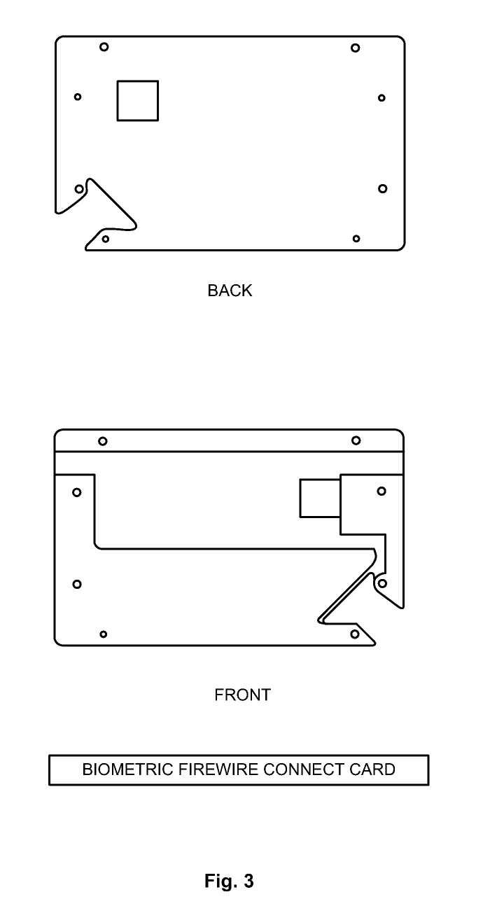

According to one embodiment as shown in FIG. 1, a card 10 includes a biometric reader element 14, a battery 16, a FireWire (IEEE 1394) connection interface element 18 and an optional magnetic stripe 12. In certain aspects, additional card elements might include a memory chip 20, a smart chip 22, one or more activation indicator LEDs 24, a tap activation switch 26 and/or a contactless antenna 28. Memory chip 20 is useful for storing biometric information of the user for use in the identification verification algorithm discussed below, and other data such as digital data relating to the card issuer and the card holder (user). Memory chip 20 may be any size, e.g., on the order of one or a few megabytes to a hundred megabytes or up to 1 or 2 gigabytes or more, so long as the card dimensions are not adversely impacted. Antenna 28 allows the card to be passed near an antenna (Reader) without any physical connectivity, to carry out a transaction. For example, antenna 28 may include or be coupled to an RFID element; the RFID activates when a signal is received by the antenna 28 from an external signal source. The contactless antenna 28 may be used for communication with remote systems such as a PC or other intelligence module. Activation LEDs 24 may be used, for example, for indicating to the user when a biometric scan is in process, when the scan has finished and/or when the card is active. Tap activation switch 26 may be used to start a biometric scan and/or to select a card type where the card 10 holds information for multiple card types as will be discussed below. Smart chip 22 can be used for contact communication as discussed below. In certain aspects, processing functionality is implemented in memory chip 20. In other aspects, a separate processing element (not shown) is provided on the card and is communicably coupled with various other on-card elements such as, for example, Firewire interface element 18, memory 20, biometric reader 14, etc.

Cards according to the present invention advantageously allow for personal information access and retrieval without the need for a PIN access code or the like. In one embodiment, a card includes a biometric reader element configured to read biometric information unique to a particular user. Biometric information can include the user's fingerprint, and/or a subsurface fingerprint. As an example, to activate the card, the user initiates biometric reading, for example, by depressing, toggling or otherwise activating tap activation switch 26, and/or by placing the biometric reader proximal the portion of the user's body to be analyzed. Once the biometric analysis has completed and the user's identity is confirmed, the card is activated and will remain so for a certain period of time (e.g., 5 seconds, 10 seconds, 1 minute, 3 minutes, or 5 minutes, etc). This time period is configurable by a user, in one aspect. Also, the user may configure the card to deactivate after information has been read from the card, e.g., after the card has been swiped in a card reader. Once activated, the card can be used, e.g., swiped in an ATM machine or swipe card reader, until the card deactivates. If connected to an external system via the firewire interface, the card when activated may be used to transfer information over the firewire interface to and from a connected device or network. For example, where the card is used for online gaming, online gambling or online shopping, an activated card can be used to conduct an online transaction, verify identity, etc. through a computer system or other communication device coupled to the Internet or other network. In online gambling, a confirmed identity of the user can be used for tax purposes.

One example of a useful biometric reader element 14 is based on Lumidigm's LightPrint™ technology, which combines spectral measurements with imaging, resulting in a multispectral fingerprint sensor. Lumidigm's LightPrint technology collects a multicolored image of the features of the skin that lie below the surface. This “internal fingerprint” is a complex structure of collagen and blood vessels that mimic and dictate the surface fingerprint pattern. This subsurface pattern is not subject to the same wear and aging effects as the external fingerprint ridges. In particular, a useful biometric sensor is the LumiGuard™ sensor from Lumidigm. In operation, a small, low-power beam of light illuminates or scans an appropriate skin site, such as the finger, hand or wrist, of the user. The measurement is then analyzed to confirm the identity of the user using a spectral analysis algorithm. The LumiGuard™ algorithm is designed to verify identity based on the optical properties of the skin. The algorithm uses sophisticated multivariate analysis techniques to extract the biometric signature from the measured optical spectrum. The system compares the measured data to an authorized biometric signature on record, e.g., stored in memory 20. If the two biometric signatures “match”, e.g., are determined to be mathematically equivalent, then authorization is granted. In certain aspects, all or a portion of the algorithm may be executed by a separate on-card processing element.

FIG. 5 illustrates another embodiment of multipurpose card 200 that includes or implements functionality for more than one card type on a single physical card. In this embodiment, a user is able to selectively store and activate any of a plurality of card types, such as a bank card, a credit card, an ATM card, etc. For example, a user may load information onto a card for each of a variety of specific card types. As an example, as shown in FIG. 5b, a user has loaded information for the following card types: Visa, Mastercard, Bank of America (Bank Card), Chevron gas, American Express and Gate Pass. To load information, the user may connect the interface 18 to a computer or network and download the pertinent account information. For example, when connected to a computer system, the user may directly enter the account information (account number, expiration date, etc) pertinent to a specific card type, and associate that specific information with one of the indicators 250. To associate the information with a specific indicator 250, the user may select an indicator, for example using tap activation switch 26 to cycle through the indicators 250 until the desired indicator is selected or lit. Alternately, or additionally, account information can be provided over a network connection from a card issuer. Account information may also be preloaded on a multipurpose card provided to a user, For example, a credit card company may issue a multipurpose card to the user, with the user's account information for that credit card issuer preloaded and pre-associated with one of the indicators. The user may then enter or download account information for other card types. In card embodiments including a multimedia portion, the multimedia portion can include software for download to a users computer, which when executed provides a graphical user interface to facilitate account information entry and download to a multipurpose card.

In certain aspects, the user may also configure a card (10, 100, 200) to deactivate after a card has been active for a certain amount of time and/or after has been swiped or after account information has otherwise been read from the card. This is useful to prevent unwanted use of the card. For example, the user can set the card to deactivate after being active for a certain period of time, e.g., one minute, or after the card has been read, whichever occurs first. In this manner, if the user loses the card or the card is otherwise improperly taken, it will be useless unless and until the user's biometric information is again read to re-activate the card.

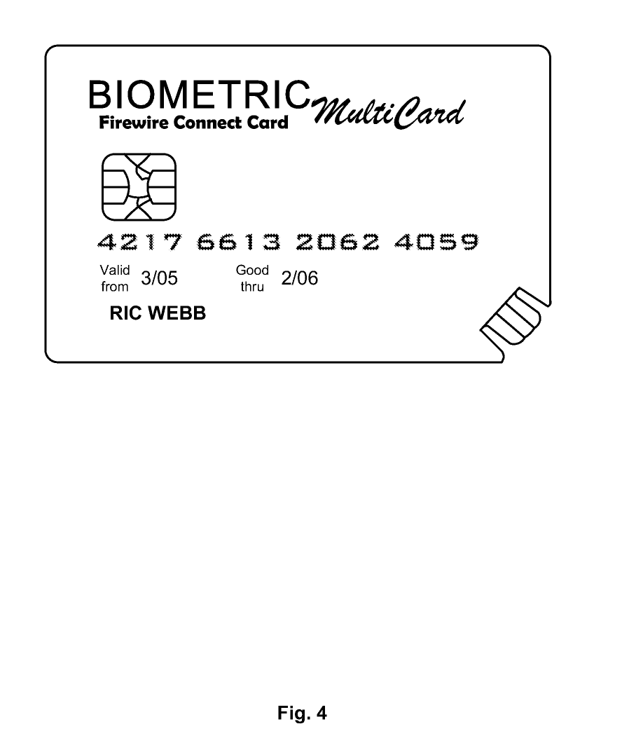

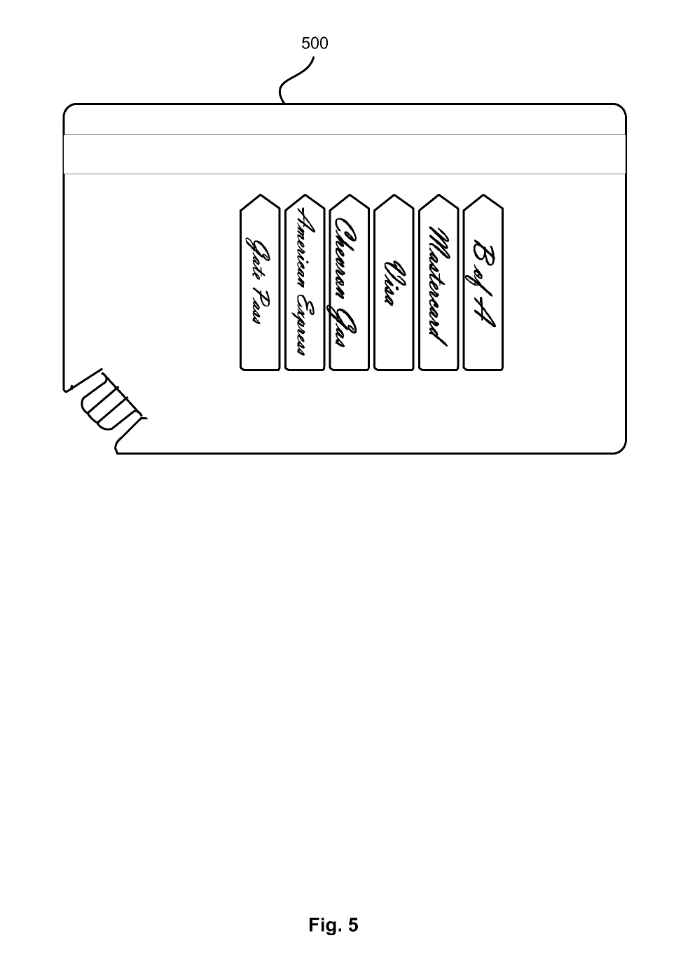

To use the multipurpose card 200 shown in FIGS. 4 and 5, the user activates the biometric reader and performs a biometric scan to confirm the user's identity and activate the card. The user may then use tap switch 26, e.g., by tapping the card while the biometric reader is active, to cycle through the card types as indicated by indicators 50. Alternately, a button or other switch element can be implemented in the card to allow a user to cycle through and select the card type. Once the desired card has been selected, the user removes their finger from the biometric reader to lock the multipurpose card into the card type selected. The user may then use the card themselves or hand it to someone else, e.g., a salesperson, for use or swiping. The selected card type remains active for any pre-configured duration or until the card has been read if the user has configured deactivation after reading. In certain aspects, different card types may be configured with different de-activation time durations. As an example, a user may configure the card such that a credit card or Diners Club card selection remains active for 5 minutes to allow sufficient time for a waitperson to carry the card away, swipe it and return with the bill, whereas a bank card selection remains active for only 15 or 30 seconds.

In embodiments including multiple card type functionality, it is preferred that the card has no embossed information such as account numbers, however, a card issuer may include such information if desired. Additionally, although only 6 card type indicators are shown in FIG. 5b, it should be appreciated that as few or as many different cards and card types as desired may be implemented on a single physical card.

In certain aspects, to determine that the card has been read or swiped an electronic switch element detects or measures a draw in current associated with a swipe or read event. The electronic switch may be electrically coupled to one or more elements on the card such as a magnetic stripe, smart chip, contactless RFID element, Firewire interface, etc. . . . .

A card (10, 100, 200) including a smart chip 22 can be inserted physically into a smart card reader to initiate a transaction. Such cards may have a small square gold plate about ½″ in size on the front panel, for example instead of, or in addition to, magnetic strip 12. When the card is inserted into a smart card reader, it makes contact with electrical connectors that transfer data to and from the chip. The bank card portion may further include raised or embossed data illustrating the bank card number that has been issued by the issuer and to the bank card holder. The raised data also allows for the bank card portion to be swiped by existing mechanical friction swiping mechanisms typically used in a credit card situation, such as at a restaurant or other location that does not have an electronic card reader mechanism.

In certain aspects, the card may include indicia, which further provides an opportunity for advertisement for an affiliate or the bank card issuer, or further surface area for printing information relating to the bank card holder. The back side and/or the front side of the card also may include an additional barcode to allow for scanning for information relating to the purchase or distribution channels of the card. A barcode also allows for the card to be an item that may be purchased at a point of sale at any location capable of conducting such a transaction.

As shown in the Figures, the biometric reader element (14, 114) is positioned in the upper right portion of the card, however, it should be appreciated that the biometric reader element may be positioned in any other location on the card. In one aspect, for example, it is preferred that the biometric reader element be positioned in a location away from the magnetic stripe, such as the bottom of the card where the stripe is at the top. In this aspect, the bottom can have a greater thickness (e.g., 0.072 mil) than the top portion with the stripe (e.g., 0.030 mil) so as to accommodate a larger form factor biometric reader. This may reduce costs as smaller form factor readers would tend to be more expensive. Also, it is desirable that the portion of the card with the magnetic stripe have a thickness compatible with ATM machines and stripe card readers, typically 0.030 mil. Additionally, positioning the biometric reader away from the stripe helps prevents interference with the fabrication and use of the stripe. It should be appreciated, however, that a small form biometric reader may be used in conjunction with a magnetic stripe and that the reader may be positioned anywhere on the card.

The Firewire (e.g., Firewire 400 or Firewire 800 specification) interface advantageously allows for charging of the battery 16 when connected to an external source such as a computer system or other powered device. It should be appreciated that any other connection interface may be used, such as, for example, USB, USB 2.0, etc. In certain aspects, an external ISO standard casing module may be attached to Firewire interface if the integrated firewire interface 18 is not ISO standard. A standard casing module may be used for other standards as well, such as USB, USB2.0, etc.

In one aspect, the card 100 can be used as simply a storage card for storing personal information of a user in a secure manner. For example, information can be stored to and retrieved from the memory 20 over the connection interface 18, and/or via strip 12, and/or via the smart chip 22 and/or via RFID, etc.

According to one aspect, the card includes a feature that enables and accepts the insertion of an external storage card or device “chip” into the card, which the card can read, access and utilize for various purposes. The chip can be used to store any electronic or other data information etc. and can be removed, swapped, used on multiple cards, etc. For example, the card will be able to accept a micro SD card or device or other similar storage card. In certain aspects, the chip includes a solid state memory device such as a flash memory device that is embedded in the card or that is enclosed in a memory card. In certain aspects, the card includes a docking bay or other means to releasably connect a memory card with the card. In certain aspects, a flash memory device is enclosed in a memory card selected from the group consisting of a COMPACTFLASH card, a SmartMedia card, a MultiMedia card, a Secure Digital card, a Memory Stick card and an xD card. In certain aspects, the flash memory may be embedded in, or coupled with, the connector element (e.g., FireWire, USB connector).

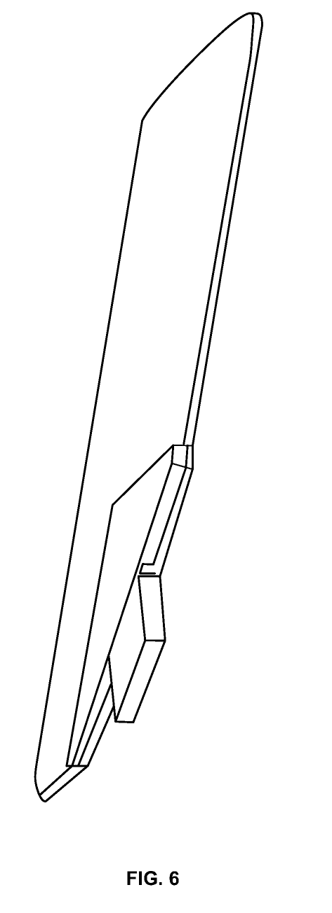

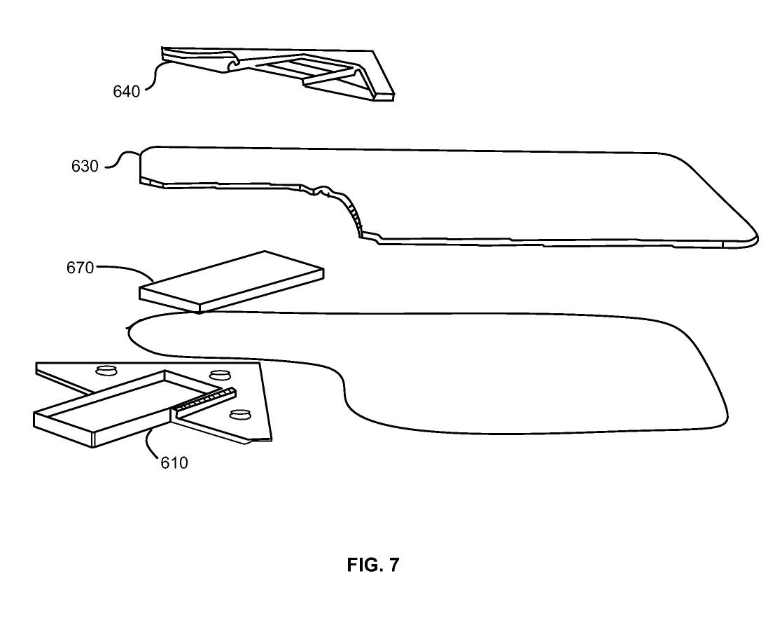

In one embodiment, a single purpose card, i.e., individual storage card, is provided. In certain aspects, a connector is attached to a card the thickness of a credit or bankcard (commonly referred to as a CR-80 plastic card). In this embodiment, the card can be embossed and a magnetic stripe can be added to the card. FIG. 6 illustrates such a card according to one embodiment. FIG. 6a shows an isometric view of a card with a connector element that is substantially the same thickness as the card. FIG. 6b illustrates a side view with elements of the connector element shown in a detached state. Element 610 is a USB connector element configured to hold the memory (e.g., flash memory device) 620 and also provides the bottom of the base that securely attaches to the plastic card 630. Element 640 is the top cover portion mates with element 610 to secure the USB connector in place attached to the plastic card 630 as shown in FIG. 6a. The flat surface of the card, in certain aspects, is the standard thickness of a bankcard, e.g., 0.76 mm thick. The custom molded unit is securely attached to the card portion 630, and the attached unit contains both the flash memory and USB connector. The assembled card is flexible and can be carried in ones wallet, for example, and easily read in a swipe-style magnetic stripe card reader in embodiments having a magnetic stripe on the card portion 630. It should be appreciated that other connector elements with different protocols may be used, such as FireWire, etc.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, a card might include a one-time password generator that generates a password for display on a miniscreen. Additionally, a card might be shaped to represent an object or shape that promotes a product and/or the entity distributing or selling the card. Therefore, the scope of the appended claims should be accorded the broadest interpretation so as to encompass all such modifications and similar arrangements.

What is claimed is:

1. A card comprising:
a biometric reader element for activating the card;
one of a FireWire connection interface element or a Universal Serial Bus connection interface element; and
a memory for storing information, including information personal to a user.

2. A card of claim 1, wherein information specific to a plurality of different card types is stored in the memory, the card further including
a selection element that allows a user to select one of the plurality of card types, wherein upon selection by a user of a card type, the selected card type is activated such that information available from the card corresponds only to the activated card type.

3. The card of claim 2, wherein the plurality of card types include card types selected from the group consisting of a Visa card, a Mastercard card, a gas card, an American Express card.

4. The card of claim 2, wherein the selection element includes a button or switch element.

5. The card of claim 2, wherein the selection element includes a plurality of buttons.

6. The card of claim 1, wherein the memory includes a solid state memory device.

7. The card of claim 6, wherein the solid state memory device includes a flash memory device.

8. The card of claim 7, wherein the flash memory device is embedded in the card.

9. The card of claim 7, wherein the flash memory device is embedded in the connection interface element.

10. The card of claim 7, wherein the flash memory device is enclosed in a memory card selected from the group consisting of a COMPACTFLASH card, a SmartMedia card, a MultiMedia card, a Secure Digital card, a Memory Stick card and an xD card.

11. The card of claim 10, wherein the card further includes a docking bay to releasably connect with the memory card.

12. The card of claim 1, wherein the card is shaped to represent an object or shape that promotes a product and/or the entity distributing or selling the card

13. A method of activating a card having a biometric reader element, a Firewire or Universal Serial Bus (USB) connector element and a memory for storing information personal to a user, the method comprising:
activating the biometric reader element, and
performing a biometric scan of a user to activate the card.

14. The method of claim 6, further including connecting the card to a device or network using the connector element and transferring information between the memory and the device or network over the connector element.

15. The method of claim 6, wherein performing a biometric scan includes obtaining spectral measurements of a user's skin and comparing the spectral measurements with information stored in the memory.

16. The method of claim 6, wherein information specific to a plurality of different card types is stored in the memory, and wherein the card further includes a selection element that allows a user to activate one of the plurality of card types, and wherein the method further includes activating a specific card type using the selection element, whereby information in the memory specific to that card type is made accessible to a card reader or a system connected with the connector element.

17. The card of claim 1, wherein the card is usable after activation by a user, wherein a user activates the card by using the biometric reader element to perform a biometric scan of the user's skin, whereby the card is activated upon a positive comparison of the biometric scan measurement with data stored in the memory.

18. A card comprising:
a memory for storing information specific to a plurality of different card types; and
a selection element that allows a user to select one of the plurality of card types, wherein upon selection by a user of a card type, the selected card type is activated such that information available or accessible from the memory of the card corresponds only to the activated card type.

19. The card of claim 18, further including one of a FireWire connection interface element or a Universal Serial Bus connection interface element.
